(19) United States
(12) Patent Application Publication
(10) Pub. No.: US 2019/0380539 A1
(43) Pub. Date: Dec. 19, 2019

(54) FOOD PROCESSOR WITH ENHANCED LID HANDLE AND PROCESS FOR OPERATION THEREOF

(71) Applicant: FLAMA, FÁBRICA DE LOUÇAS E ELECTRODOMÉSTICOS, SA, Cesar (PT)

(72) Inventor: Luis ALVES, Cesar (PT)

(21) Appl. No.: 16/556,269

(22) Filed: Aug. 30, 2019

Related U.S. Application Data
(63) Continuation of application No. PCT/PT2018/000005, filed on Apr. 10, 2018.

(30) Foreign Application Priority Data
Apr. 17, 2017 (PT) 110030

(51) Int. Cl. A47J 43/07

(52) U.S. Cl. CPC A47J 43/0761; A47J 43/0716

(57) ABSTRACT

A food processor comprises a recipient and a lid adapted for being retained in removable manner in the recipient, whereby the lid comprises a lid handle presenting enhanced gripping ergonomics in view of a better handling thereof and of preventing thermal injury hazards.

The present invention further refers to a process for operation of a food processor with enhanced gripping ergonomics of a respective lid.

### CROSS-REFERENCES TO RELATED APPLICATION

This application is a continuation of copending International Application No. PCT/PT2018/000005, filed Apr. 10, 2018, which is incorporated herein by reference in its entirety, and additionally claims priority from Portuguese Application No. PT 110030, filed Apr. 17, 2017, which is incorporated herein by reference in its entirety.

The present invention refers to the field of food processors presenting a recipient and lid arrangement, in particular to a lid that is adapted for being securely retained on a respective recipient.

### BACKGROUND OF THE INVENTION

Known technology includes several solutions relating to food processing systems presenting a recipient adapted for receiving food ingredients and a respective lid adapted for providing closure of said recipient, whereby said food ingredients are processed by means of a food processing tool provided inside of said recipient and/or by means of a heating arrangement provided next to said recipient.

The WO 2005/099536 A2 and the EP 1945075 B1 disclose lids presenting a hole and a handle. Such lid handle configurations may be adapted for a lid to be placed on top of a recipient, but present handling constrains in the case of the operation of a food processor involving retention thereof in a respective recipient. Such constrains include reduced manual gripping extension and reduced gripping force momentum if said lid is to be retained in and released from a blocked position on said recipient, or if said lid presents a relatively bigger weight or dimension.

Moreover, it is known to provide a lid adapted so that can be retained in removable manner on said recipient. In same cases, said retention of the lid on the recipient is provided by reciprocal engagement means, and in some other cases, said retention is provided such that blocking means can be actuated by respective actuation means, such as by means of a button or similar.

The EP 0699409 B1 and the EP 1119279 B1 disclose a food processor that presents a lid adapted so that can be blocked on a respective recipient, and comprising actuation means adapted for actuating said blocking means.

The U.S. Pat. No. 6,554,466 B1 discloses a similar arrangement of the actuation means on a handle in the proximity of the perimeter region of the lid.

The U.S. Pat. No. 4,763,567 refers to cooking vessel with a removable top cover, whereby a handle integral with the cover includes a pistol grip portion.

In the particular case of food processors adapted for heating food ingredients, this arrangement and configuration of the lid actuation means in the proximity of the perimeter region of the lid, involve the user placing her/his hand next to the immediate opening of the recipient as this opens up thereby exposing the hand to thermal injury hazards.

Moreover, there are food processors presenting lid handles that extend over the entire cross extension of the lid. This symmetric configuration does not attach to a lid opening and does not inherently communicate the status of blocking engagement of the lid on a respective recipient.

None of the documents in known technology discloses a solution for enhanced signaling of the blocking status of the lid, associated with a lid handle.

The present invention is to provide a food processor comprising a recipient adapted for receiving food ingredients and a respective lid adapted for providing closure of said recipient, whereby said food ingredients are processed by means of at least one of a food processing tool provided inside of said recipient and a heating arrangement provided next to said recipient, and whereby said lid presents a more effective lid handle, providing enhanced force leverage in securely retaining said lid to the recipient, a safer handgrip of the lid, and a more ergonomic manual actuation and status apprehension of the lid closing and opening actuation mechanism.

### SUMMARY

According to an embodiment, a food processor for processing food ingredients may have: a recipient presenting an opening for receiving food ingredients, a lid adapted so that can be retained on said recipient, wherein said lid presents a lid handle extending between a first and a second handle supports on the upwards-oriented surface of said lid, wherein said lid is adapted so that can be moved to a closed position on said recipient, and back to an open position, by means of manually actuating said lid handle, characterized in that said lid handle provides a handgrip above the center of said lid and is off-centered in relation to said center of lid, and in that said lid handle is provided so that can be rotated around one of respective supports of lid handle in relation to a portion of said lid.

According to another embodiment, a method for operating a food processor, in particular for operating an inventive food processor may have the steps of: providing a recipient and a lid configured for being retained onto said recipient, wherein said lid presents a lid handle that extends above the top part of said lid from a perimeter region, over the center region and along most part of the cross extension of said lid; placing said lid on said recipient by manually gripping said lid handle such that said lid handle is in a first angular position relative to said recipient, advantageously at an angle of up to 45° relative to said recipient handle, retaining said lid on said recipient including by means of manually rotating said lid handle to a second, advantageously previously defined, angular position relative to said recipient, where said lid handle is aligned with said recipient handle, releasing said lid from retention on said recipient including by means of manually driving said lid handle in the opposite angular direction, such that said lid handle is removed from said second position towards said first angular position relative to said recipient handle, optionally, manually gripping said recipient handle during at least part of the time when manually gripping said lid handle.

In particular, the food processor according to the present invention comprises a lid presenting a lid handle that develops above the upwards-oriented surface of said lid and extends off-centered in relation thereto.

It is advantageous when said lid handle is provided so that extends along an extension that is off-centered in relation to the center of said lid, thereby providing a handgrip above said center of said lid, and in that said lid handle is provided so that can be rotated around one of respective supports of lid handle in relation to said lid.

It is advantageous when said lid handle is provided so that extends from a first lid handle support disposed on the perimeter region of said lid, inwards above and beyond the center of said lid, to a second lid handle support that is not provided on a perimeter region of said lid, and so that said lid handle provides a handgrip extension that is unevenly arranged in relation to the center of said lid.

Another objective of the present invention is to provide a process for operation of a food processor, including a lid adapted so that can be retained on a respective recipient by means of a more ergonomic manual handling of a respective lid handle.

The aforementioned objective is attained according to the present invention by means of a process according to claim 12.

### BRIEF DESCRIPTION OF THE DRAWINGS

Embodiments of the present invention will be detailed subsequently referring to the appended drawings, in which:

FIG. 1 shows a side view of recipient (2) and lid (3) in a food processor (1) according to the present invention;

FIG. 2 shows a perspective view from above of the recipient (2) and lid (1) according to FIG. 1, in the closed position;

FIG. 3 shows a perspective view from above of the recipient (2) and lid (1) according to FIG. 1, in the open position;

FIG. 4 shows a top view of a lid (3) according to FIG. 1, in the closed position;

FIG. 5 shows a top view of a lid (3) according to FIG. 1, in the open position;

FIG. 6 shows a side-cut view of the recipient (2) and lid (3) according to FIG. 1;

FIG. 7 shows a front view of a food processor (1) according to the present invention;

FIG. 8 shows a top view of a food processor (1) according to the present invention;

FIG. 9 shows a side view of a food processor (1) according to the present invention.

### DETAILED DESCRIPTION OF THE INVENTION

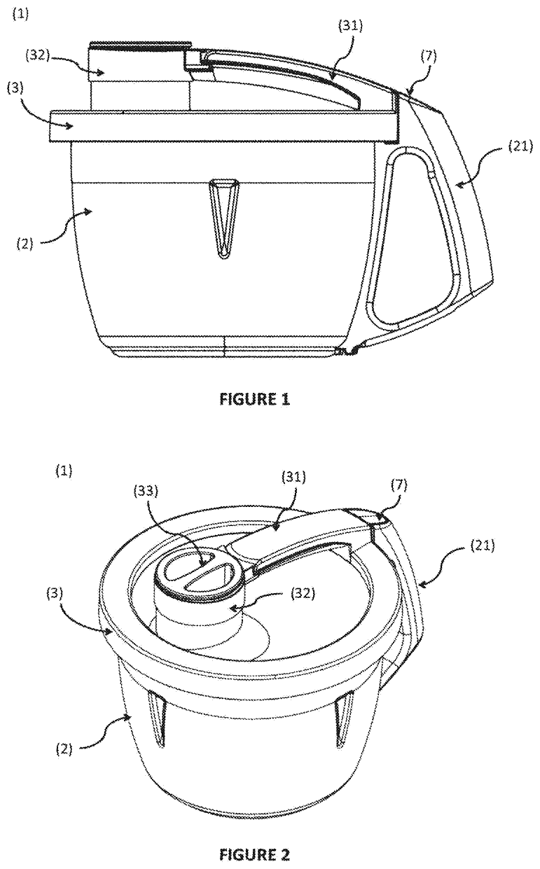

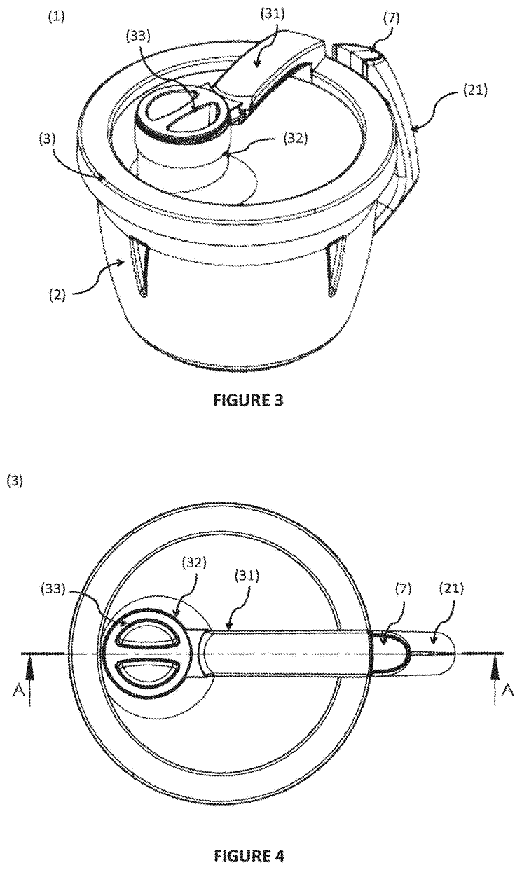

FIGS. 1 to 5 show different views of a recipient (2) and a lid (3) of a food processor (1) according to the present invention, including in a respective closed and open positions.

As known in conventional technology, said lid (3) presents an upwards side and a downwards side and is adapted so that can be securely retained in removable manner with the perimeter region of the opening of said recipient (2).

According to a first inventive aspect, said lid (3) presents a lid handle (31) that extends inwards from a perimeter region of said lid (3) corresponding to a engagement position of said lid (3) on said recipient (2), so that said lid handle (31) can be handled with reference to said engagement position, and that provides a surrounding hand handgrip extension developing above and beyond the center of said lid (3), so that said lid handle (31) can provide a bigger force leverage driving said lid (3) in a rotation movement.

According to a second inventive aspect, said lid (3) presents a lid handle (31) that is adapted so that can provide manual closing and opening actuation of said lid (3) to said recipient (2), by means of rotation of said lid handle (31) around one of respective support on said lid (3).

This arrangement advantageously provides for a more ergonomic manual grip of the lid by a single hand, thereby releasing the other hand for securing the recipient or another ongoing task.

It is advantageous when said lid handle (31) provides a handgrip extension that is unevenly arranged in relation to the diameter and radius extensions of said lid (3), so that a manual force handling of the lid (3) results more effective.

It is advantageous when said lid handle (31) provides a handgrip extension over a center region and along most part of the cross extension of said lid (3), whereby said handgrip extension is may be bigger than the radius extension of said lid (3), so that a user can easily find a handgrip support.

Moreover, this arrangement of the lid handle prevents thermal injuries to the hand grabbing the lid from hot spillovers.

It is advantageous when said lid handle (31) extends from a perimeter region of said lid (3) upwards to the top region of a lid projection (32) that extends above of said upwards side and that is arranged off centered relative to the lid (3), whereby said lid projection (32) comprises a lid opening.

According to another embodiment, said lid (3) presents a lid closure (33) adapted so that can be placed onto said lid projection (32), whereby said lid closure (33) is provided as a single piece of a transparent or semi-transparent synthetic material.

It is advantageous when said recipient (2) presents a recipient handle (21) that extends along a meridian disposition along at least part of a side wall extension of said recipient (2), and further presents blocking means (7) arranged at the top thereof and adapted for actuating a release of blocking retention of said lid (3) on said recipient (2), and when said lid handle (31) extends in a substantially continuous alignment with said recipient handle (21) when both recipient (2) and lid (3) are in a respective blocked position, so as to provide an increased manual grip surface that can be reached from said engagement position of said lid (3) on said recipient (2).

This arrangement advantageously provides for a user to handgrip the recipient with one of hand and handgrip the lid with the other hand, thereby greatly improving the ergonomics of driving said lid (3) in a rotation and vertical movements.

As depicted in FIGS. 2, 3, and 4, 5, according to another inventive aspect, said lid handle (31) is adapted so that can be rotated around a respective support on the lid projection (32). Said support may be provided on a sidewall of said generally tubular lid projection (32) and adapted so that provides for a swiveling movement of the lid handle (31) in respect there to, advantageously by an angular movement of up to 45°, advantageously up to 30°, relative to the position where said lid handle (31) is aligned with said recipient handle (21).

This arrangement advantageously provides for a more ergonomic actuation of the lid (3), in particular in view of providing a leak-tight and blocked retention of said lid (3) on said recipient (2).

According to an embodiment of the invention, said lid handle (31) is provided attached to an upper-lid part that is adapted so that can be driven in vertical and rotation movements relative to a lower-lid part, so that a manual grip of said lid handle (31) can actuate a vertical movement jointly of said upper-lid part and lower-lid part, and a rotation movement of said upper-lid part relative to said lower-lid part.

The lid (3) thus comprises a first upper part that is movably attached to a second lower part, and adapted so that can be driven in vertical movement so as to establish a sealing engagement with the perimeter region of the recipient opening. Moreover, said first upper part is adapted so that can be driven in rotation movement so as to establish a locking retention with the perimeter region of the recipient opening.

The arrangement of the lid handle (31) disclosed in the present invention thereby greatly facilitates a manual handling of a lid (3) with such vertical and rotation movements, as this can be better driven from a force applied to the top side of the lid (3), than from perimeter regions thereof.

According to an embodiment, said lid handle (31) presents an arched configuration in side view developing above the upwards oriented side of said lid (3), including at a height that increases from the perimeter region towards a center region of said lid (3).

In particular, it is advantageous when said lid handle (31) does not provide for handing grip next to the perimeter region of said lid (3), so that a hand cannot have grip in the region closest to the perimeter and therefore more exposed to thermal injury hazard.

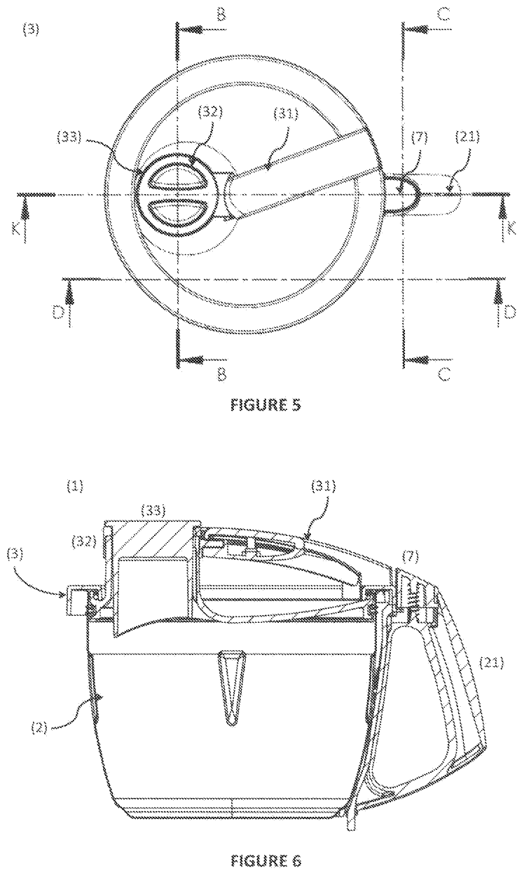

FIG. 6 shows a side-cut view of the recipient (2) and lid (3) in a closed position.

It is advantageous when said lid handle (31) is adapted so that can be supported at a perimeter region of said lid (3) and at a side region of said lid projection (32).

In particular, it is advantageous when said lid handle (31) presents a ring-like form at one edge adapted so as to engage around a top region of said lid projection (32).

Moreover, it is advantageous when said lid handle (31) presents a hand-grapping extension between said support regions, whereby said hand-grapping extension presents an upwards-oriented part and a downwards-oriented part, the cross-section of said upwards-oriented and downwards-oriented parts thereby presenting at least one of different dimension and shape.

It is advantageous when the cross-section of the upwards-oriented part is bigger than the cross-section of the downwards-oriented part of the hand-grapping extension of said lid handle (31).

Moreover, as depicted in FIG. 6, it is advantageous when the upwards-oriented surface of said lid (3) underneath said lid handle (31) is lowered in relation to the perimeter region thereof, thereby providing more space for a surrounding hand handgrip of said lid handle (31).

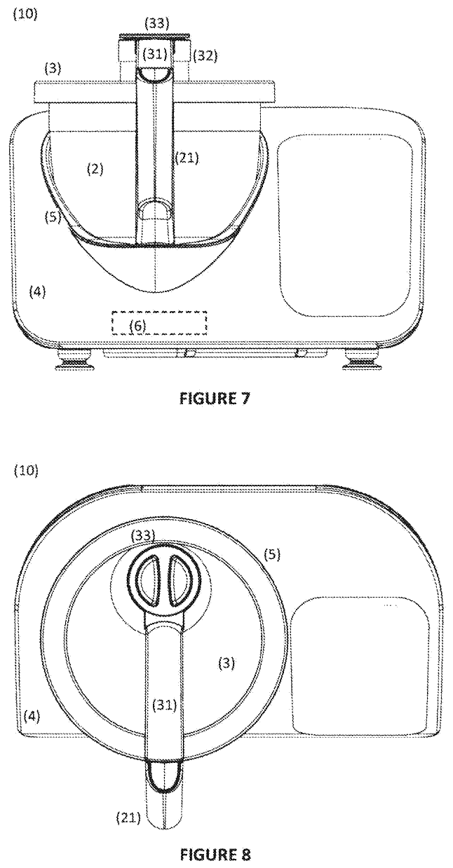

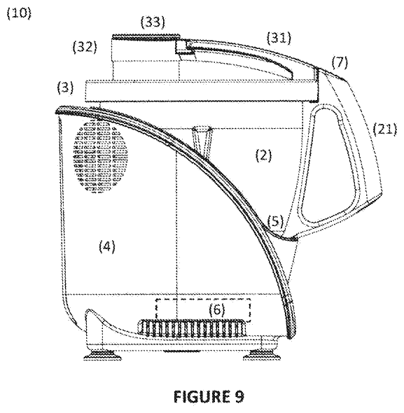

FIGS. 7 to 9 show a food processor (1) according to the present invention.

As represented, said food processor (1) further presents a casing cavity (5) and confines a driving arrangement (6) adapted to drive a food processing tool inside of said recipient (2) when said recipient (2) is operatively engaged onto said casing cavity (5). In this arrangement, said recipient (2) is adapted so that can be retained in a previously defined blocked position onto said casing cavity (5), and said lid (3) is adapted so that can be retained in a previously defined blocked position onto said recipient (2), whereby said lid handle (31) and said recipient handle (21) extend in a substantially continuous alignment away from said casing (4) when said recipient (2) and lid (3) are in said blocked position.

It is advantageous that when said lid handle (31) and recipient handle (21) are in a blocked position, there is an actuation of respective signaling means provided on at least one of said lid handle (31) and said recipient handle (21), and thus signaling a correct blocked position to a user.

A process for operating a food processor, in particular a food processor (1) according to the present invention, inventively comprises: first, manually gripping said lid handle (31) and placing said lid (3) on said recipient (2) such that said lid handle (31) is oriented in a first angular direction relative to the recipient (2), advantageously at an angle of up to 45° relative to said recipient handle (21), then retaining said lid (3) on said recipient (2) by means of manually driving said lid handle (31) to a second, advantageously previously defined, angular direction relative to said recipient (2), advantageously aligned with said recipient handle (21).

It is advantageous, when the user manually grips said recipient handle (21) with his other free hand during at least part of the time when manually gripping said lid handle (31).

Following a retention, said lid (3) can be released from said recipient (2) by means of pressing blocking means (7) arranged at the top of said recipient handle (21), thereby releasing the blocking retention of said lid (3) on said recipient (2), manually gripping said lid handle (31), and manually driving said lid (3) such that said lid handle (31) is removed from second direction relative to the recipient (2), in the opposite direction to the retention movement, thereby releasing said lid (3) from retention on said recipient (2).

It is advantageous when said retention of the lid (3) on said recipient (2) further includes manually grabbing said lid handle (31), pushing said lid (3) in a vertical movement downwards and then in a rotation movement around its central axis, thereby rotating said lid handle (31) in respect of a swiveling support thereof arranged at said lid projection (32), until said lid handle (31) is substantially aligned with said recipient handle (21).

According to a embodiment, the process further includes retaining said recipient (2) on a respective casing (4), such that said recipient handle (21) and said lid handle (31) are in a substantially continuous extension orthogonal to the front of said casing (4).

It is advantageous when said retention of said lid (3) on said recipient (2) further includes the steps of appraising a correct blocking position by means of sensors, providing respective appraisal result to a control arrangement of said food processor (1), and displaying the blocking condition of said lid (3) on said recipient (2) by means of display means provided on said lid handle (3).

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A food processor for processing food ingredients presenting:
a recipient presenting an opening for receiving food ingredients,
a lid adapted so that can be retained on said recipient, wherein said lid presents a lid handle extending between a first and a second handle supports on the upwards-oriented surface of said lid,
wherein said lid is adapted so that can be moved to a closed position on said recipient, and back to an open position, by means of manually actuating said lid handle,
wherein
said lid handle provides a handgrip above the center of said lid and is off-centered in relation to said center of lid, and in that said lid handle is provided so that can be rotated around one of respective supports of lid handle in relation to a portion of said lid.

2. The food processor according to claim 1, wherein said lid handle extends from a first lid handle support disposed on the perimeter region of said lid, above and beyond the center of said lid, to a second lid handle support that is not provided on a perimeter region of said lid, and so that said lid handle provides a handgrip extension that is unevenly arranged in relation to the center of said lid, and in that said lid handle is adapted so that can be rotated by a predefined angular extension around a second lid handle support, between a closed position, where said lid can be retained on said recipient, and an open position, where said lid can be removed from said recipient, and vice-versa.

3. The food processor according to claim 1, wherein said lid handle provides handgrip along an extension that is bigger than the radius of said lid, and in that said lid handle is adapted so that can be manually rotated in an angular extension of up to 90°, advantageously in only one direction, for example counter-clockwise, from a corresponding closed position to an open position of said lid on said recipient.

4. The food processor according to claim 1, wherein said lid handle extends from a first lid handle support provided on the perimeter region of said lid to a second lid handle support provided as a swiveling support on a lid projection that extends above of said upwards side and that is arranged off centered relative to the lid, wherein said lid projection may comprise a lid opening adapted for providing an optional passageway through said lid.

5. The food processor according to claim 1, wherein said lid handle presents an arched configuration in side view developing above the upwards oriented side of said lid, comprising at a height that continuously increases from the perimeter region towards a center region of said lid, wherein said lid handle does not provide for handing grip next to the perimeter region of said lid, thereby preventing a hand being placed in the vicinity of the edge of said lid.

6. The food processor according to claim 1, wherein said lid handle is provided attached to an upper-lid part that is adapted so that can be driven in rotation movement relative to a lower-lid part, by means of moving said lid handle relative to a respective second lid support.

7. The food processor according to claim 1, wherein said lid handle is provided so that a manual grip of said lid handle can actuate a vertical movement jointly of said upper-lid part relative to said lower-lid part, and a rotation movement of said upper-lid part relative to said lower-lid part.

8. The food processor according to claim 1, wherein said lid handle is adapted so that can be attached with a perimeter region of said lid and with a top region of said lid projection, wherein said lid handle may present a ring-like form at one edge adapted so as to engage around a top region of said lid projection, and in that said lid handle presents an upwards-oriented part and a downwards-oriented part, wherein the cross-section of said upwards-oriented and downwards-oriented parts presents at least one of a different dimension and a different shape, advantageously wherein the cross-section of said upwards-oriented part is bigger than the cross-section of said downwards-oriented part

9. The food processor according to claim 1, wherein said recipient presents a recipient handle that extends along at least part of the side wall of said recipient, and further presents a blocking unit arranged at the top thereof and adapted for providing blocking and un-blocking of said lid on said recipient, and in that said lid handle extends in a substantially continuous alignment with said recipient handle when said recipient and lid are in a closed position, thereby providing increased manual grip surface that can be reached from said engagement position of said lid on said recipient.

10. The food processor according to claim 1, wherein said lid presents a lid closure adapted to be placed onto said lid projection, wherein said lid closure presents a cup-like format and is provided as a single piece of a transparent or semi-transparent synthetic material.

11. The food processor according to claim 1, characterized
in that said food processor further presents a casing presenting a casing cavity and confines a driving arrangement adapted to drive a food processing tool inside of said recipient when said recipient is operatively engaged onto said casing cavity, and
in that in that said recipient is adapted so that can be retained in a previously defined blocked position onto said casing cavity, and
in that said lid is adapted so that can be retained in a previously defined blocked position onto said recipient,
wherein said lid handle and said recipient handle extend in a substantially continuous alignment away from said casing when said recipient and lid are in said blocked position, thereby actuating a respective signaling unit provided on at least one of said lid handle and said recipient handle.

12. A process for operating a food processor, in particular for operating a food processor according to claim 1, said process comprising:
providing a recipient and a lid configured for being retained onto said recipient, wherein said lid presents a lid handle that extends above the top part of said lid from a perimeter region, over the center region and along most part of the cross extension of said lid;
placing said lid on said recipient by manually gripping said lid handle such that said lid handle is in a first angular position relative to said recipient, advantageously at an angle of up to 45° relative to said recipient handle,
retaining said lid on said recipient comprising by means of manually rotating said lid handle to a second, advantageously previously defined, angular position relative to said recipient, where said lid handle is aligned with said recipient handle,
releasing said lid from retention on said recipient comprising by means of manually driving said lid handle in the opposite angular direction, such that said lid handle is removed from said second position towards said first angular position relative to said recipient handle,
optionally, manually gripping said recipient handle during at least part of the time when manually gripping said lid handle.

13. The process according to claim 12, wherein said retention of said lid on said recipient further comprises manually grabbing said lid handle, pressing said lid downwards and then rotating said lid handle in respect of a swiveling support thereof arranged at said lid projection, advantageously by an angular extension of at most 90°, thereby rotating a first upper-part of said lid relative to a second lower-part of said lid, until said lid handle is substantially aligned with said recipient handle, thereby being engaged by a blocking unit arranged at the top of said recipient handle, and in that said releasing of said lid from said recipient pressing comprises pressing said blocking unit, thereby releasing the blocking retention of said lid on said recipient, and then manually driving said lid handle from said second position to said first position relative to said recipient handle.

14. The process according to claim 12, further comprising retaining said recipient on a respective casing, such that said recipient handle and said lid handle are in a substantially continuous extension orthogonal to the front of said casing.

15. The process according to claim 12, wherein said retention of said lid on said recipient further comprises:
appraising a correct blocking condition of said lid on said recipient by means of sensors, and providing respective appraisal result to a control arrangement of said food processor;
displaying the blocking condition, comprising correct or not correct, of said lid on said recipient by means of a display unit provided on at least one of said recipient handle and lid handle.
